(19) United States
(12) Patent Application Publication
(10) Pub. No.: US 2009/0261533 A1
(43) Pub. Date: Oct. 22, 2009

(54) Seal member

(76) Inventor: Tadatoshi Inoue, Kumamoto-ken (JP)

Correspondence Address: BACON & THOMAS, PLLC, 625 SLATERS LANE, FOURTH FLOOR, ALEXANDRIA, VA, 22314-1176, US

(21) Appl. No.: 11/990,994

(22) PCT Filed: Aug. 30, 2006
(86) PCT No.: PCT/JP2006/317100

§ 371 Date: Feb. 26, 2008

(30) Foreign Application Priority Data
Aug. 31, 2005 (JP) 2005-251712

(51) Int. Cl. F16J 15/02; B65D 53/02

(52) U.S. Cl. 277/648

(57) ABSTRACT

A seal member capable of maintaining, increasing, and stabilizing sealability by preventing it from being deteriorated with time and interposed between a container body and a cover body to seal therebetween. The seal member comprises an endless part fitted to a fitting groove formed in the cover body and a projected piece formed extendedly from the endless part so that its tip part is brought into contact with the container body to seal a contact portion between the container body and the cover body. The projected piece comprises a contact piece brought into contact with the contact surfaces of the container body and the cover body to seal therebetween. The contact piece is formed of two sheets of lip parts of fork shape in cross section.

### TECHNICAL FIELD

The present invention relates to a seal member for sealing a gap between a fit body and a fitted body which are fitted to each other, and especially relates to a seal member which is preferably used for a thin plate storage container whose interior is required to be kept in clean in order to transport and store a thin plate such as a semiconductor wafer and mask glass which must be prevented from dust entry.

### BACKGROUND ART

As a fit body and a fitted body which are fitted to each other, there is a thin plate storage container used when a thin plate such as a semiconductor wafer is transported and stored for example. Such thin plate storage container is configured by including a carrier, a container body, a lid, a press member, a seal member, and so on as in Patent document 1 for example. And, the seal member is configured as shown in FIG. 2.

This seal member 1 is composed of an endless part 2, a protruding part 3, a fitting rib 4, and a projection for positioning 5. The endless part 2 of the seal member 1 is supported by being fitted to a fit retaining groove 7 of a lid 6. By using the endless part 2, the protruding part 3 is supported with extending to a side of a container body 8, and a tip of the protruding part 3 is supported by contacting to the container body 8.

### Patent Document 1: Japanese Patent Laid-open No. 2002-68364

### DISCLOSURE OF THE INVENTION

### Problems to be Solved by the Invention

The seal member 1 in above mentioned Patent document 1, however, has a configuration which realizes the sealing by using the endless part 2 and the protruding part 3. Specifically, when the fitting rib 4 of the endless part 2 elastically contacts to an inner wall surface in the fit retaining groove 7, the endless part 2 is supported in the fit retaining groove 7 due to the fitting rib 4′s own elasticity. In this status, a gap between the lid 6 and the container body 8 is sealed by contact of the tip of the protruding part 3 with the container body 8. For this reason, providing the fitting rib 4 also with the endless part 2, the sealing performance of a gap between the endless part 2 and the fit retaining groove 7 is required to be improved.

There, however, are problems in that, when the elasticity of the fitting rib 4 is weakened because of aging deterioration, heating, and so on, the force pressing the fitting rib 4 into the fit retaining groove 7 is weakened, which results in deterioration of the supporting force and the sealing performance.

### Means to Solve the Problems

The present invention is realized with considering above mentioned point, and intends to provide a seal member which is able to suppress lowering of sealing performance due to aging deterioration. Particularly, since an endless part is fitted and pressed with high pressure for a long time to a fitting groove when the endless part is made to have a sealing function, elasticity of a protruding part easily deteriorates. On the other hand, since pressing force of the protruding part to a container body is weaker than that of a fitting rib to a fit retaining groove and is released in opening and closing of the container, aging deterioration of the elasticity of the protruding part is significantly low compared to that of the fitting rib. For this reason, the present invention maintains and improves the sealing performance through improvement of the protruding part side. That is to say, the present invention is a seal member which intervenes between a fit body and a fitted body which are fitted to each other and seals a gap therebetween including: an endless part for fitting to a fitting groove provided to either the fit body or the fitted body; and a protruding part which is formed by extending from the endless part and which, through contacting of tip parts thereof, seals the contacting parts, wherein the protruding part contacts to contacting surfaces of the fit body and the fitted body and seals a gap therebetween.

According to above described configuration, it is not necessary to seal a gap between the fitting groove and the endless part when the protruding part contacts to the contacting surfaces of the fit body and the fitted body respectively and seals a gap between them.

### EFFECT OF THE INVENTION

As above description in detail, it is not necessary to seal a gap between the fitting groove and the endless part when the protruding part contacts to the contacting surfaces of the fit body and the fitted body respectively and seals a gap between them. For this reason, conventional deterioration of the sealing performance caused by the aging deterioration in the endless part can be prevented. As a result, the sealing performance can be maintained and improved. Furthermore, since a sealing action by the protruding part is also caused, in addition to elasticity possessed by the protruding part itself, by outside atmospheric pressure acting in a status where the protruding part contacts a contacting surface, the sealing member can be long-lived and furthermore quality of a semiconductor wafer and the like stored in a container can be kept certainly.

### BRIEF DESCRIPTION OF THE DRAWINGS

FIG. 1 is a sectional view showing a seal member of the present invention.

FIG. 2 is a sectional view showing a conventional seal member.

FIG. 3 is an exploded perspective view showing a thin plate storage container using a seal member of the present invention.

FIG. 4 is a perspective view showing a thin plate storage container using a seal member of the present invention.

FIG. 5 is a sectional view showing a first modification example.

FIG. 6 is a sectional view showing a second modification example.

FIG. 7 is a sectional view showing a third modification example.

### EXPLANATION OF REFERENCE NUMERALS

21 Thin plate storage container
22 Wafer supporting shelf
23 Container body
23A, 24A Contacting surfaces
24 Lid
25 Seal member
27 Lid-receiving part
27A Vertical plate part
27B Horizontal plate part
29 Fitting groove
29A Inner wall
29B Outer wall
31 Endless part
32 Protruding part
33 Contacting part
33A, 33B Lip parts

### BEST MODE FOR CARRYING OUT THE INVENTION

Based on attached drawings, an embodiment of the present invention will be described below. A seal member of the present invention intervenes between a fit body and a fitted body which are fitted each other and is for sealing a gap between them. Particularly, the seal member is suitable for use in a thin plate storage container and the like whose internal space is required to be clean status. In addition, the thin plate storage container is used for housing a thin plate such as a semiconductor wafer, a storage disk, a liquid crystal glass substrate, and a mask glass which must be prevented from dust entry when storing and transporting them. Described here is an example where the seal member of the present invention is used in the thin plate storage container which houses a thin plate such as the semiconductor wafer.

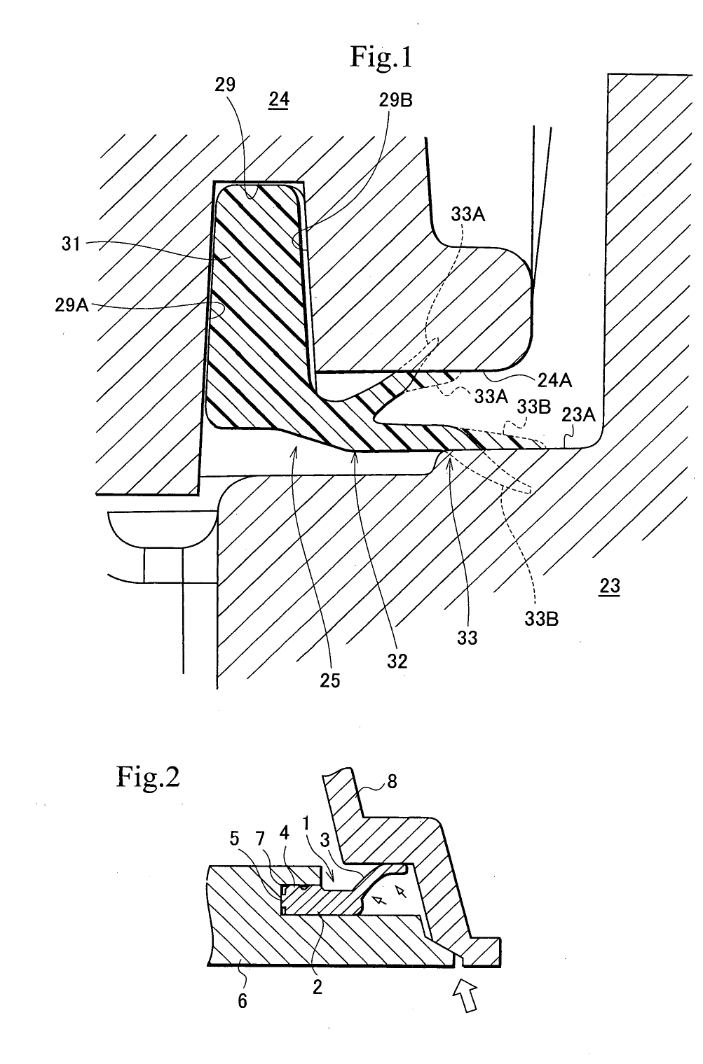

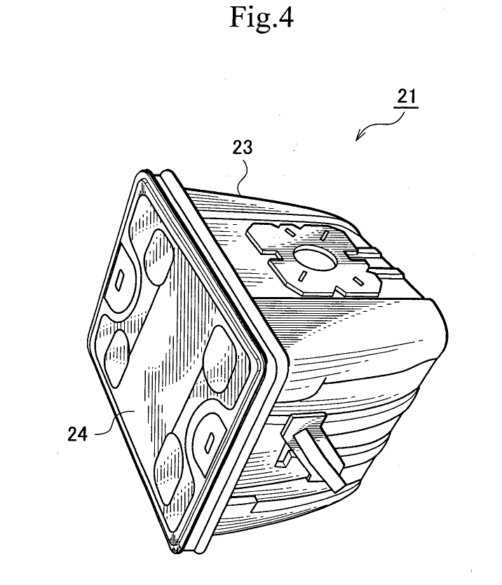

At first, the thin plate storage container using the seal member of the present invention will be explained based on FIGS. 1, 3, and 4.

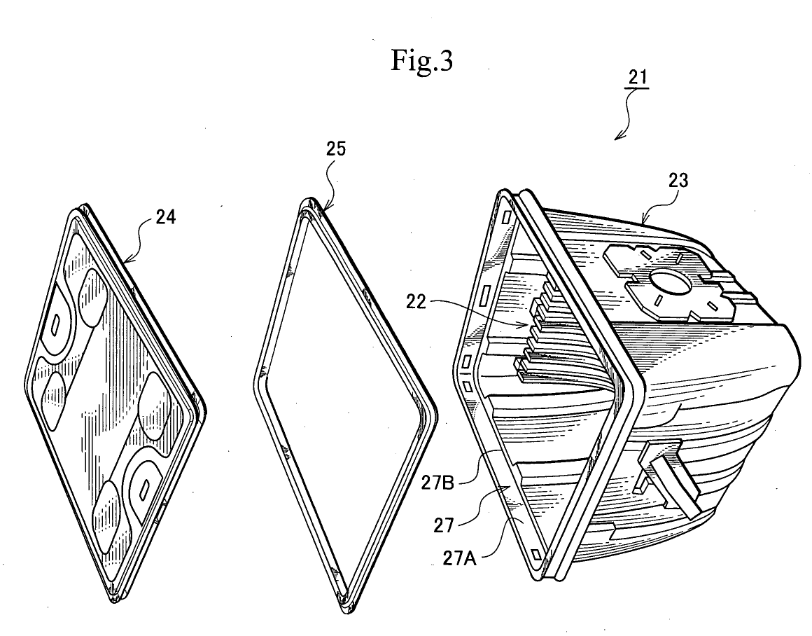

As shown in FIG. 3, a thin plate storage container 21 of the present embodiment is composed of a wafer supporting shelf 22, a container body 23, a lid 24, and a seal member 25.

The wafer supporting shelf 22 is a member for supporting a thin plate such as a semiconductor wafer housed in the container body 23 from both sides of the thin plate. The wafer supporting shelf 22 is provided to side walls facing each other in the container body 23, respectively. Many thin plates such as a semiconductor wafer are supported in parallel by this wafer supporting shelf 22.

The container body 23 is a container for housing a plurality of thin plates such as a semiconductor wafer. In a status where a plurality of thin plates is housed in this container body 23, the container body 23 is tightly sealed and entry of dust and the like from outside is prevented. That is to say, two wafer supporting shelves 22 are mounted in the container body 23, the container body 23 is tightly sealed in a status where a plurality of thin plates is housed in this container body 23 with being supported between these two wafer supporting shelves 22, and entry of dust and the like from outside is prevented. The wafer supporting shelf 22 is configured as a discrete part separated from the container body 23 here, however, it is obvious that the wafer supporting shelf 22 and the container body 23 may be configured integrally.

A lid-receiving part 27 to which the lid 24 fits is provided to an opening end part of the container body 23. The lid-receiving part 27 is formed with enlarging the opening end part of the container body 23 to be a dimension of the lid 24. According to this, the lid 24 is configured so as to be mounted to the lid-receiving part 27 by fitting to an inside of a vertical plate part 27A of the lid-receiving part 27 and contacting to a horizontal plate part 27B. Furthermore, a seal surface (not shown in the drawings) is provided to a whole circumference of the horizontal plate part 27B, and the thin plate storage container 21 is tightly sealed by the seal member 25 mounted to the lid 24 contacting to the seal surface.

The lid 24 is a member for closing the container body 23. The lid 24 closes and tightly seals the container body 23 in a status where thin plates are housed in the container body 23. A simplified detachable mechanism (not shown in the drawings) for securing the lid 24 to the container body 23 is provided in the lid 24. This simplified detachable mechanism includes a lid locking pawl (not shown in the drawings) projecting from a periphery part of the lid 24. A press member (not shown in the drawings) for supporting thin plates supported in two wafer supporting shelves 22 in the container body 23 from a side of the lid is provided to an inside surface of the lid 24 (a surface of the container body 23)

To an end part of the lid 24 on a container body 23 side, an annular fitting groove 29 (see FIG. 1) is provided over a whole circumference thereof. This fitting groove 29 is provided to an edge part in a bottom end of the lid 24 over a whole circumference and configured by including an inner wall 29A and an outer wall 29B. The inner wall 29A and the outer wall 29B are formed with slightly slanting in a tapered shape.

The seal member 25 is a member for tightly sealing the container body 23 by intervening between the container body 23 and the lid 24 and sealing a gap between them. Specifically as shown in FIG. 1, this seal member 25 is configured by including an endless part 31 fitted to the annular fitting groove 29 on a lid 24 side and a protruding part 32 which is formed by extending from the endless part 31 to outside and which, through contacting of tip parts thereof to the upper and lower contacting surfaces 23A and 24A respectively, seals the contacting parts. This seal member 25 is composed of an elastic member such as a synthetic resin and is wholly able to bend flexibly.

The endless part 31 is configured as an annular member fitted to the annular fitting groove 29 on the lid 24 side. This endless part 31 is formed in a same shape as the fitting groove 29 and fits into the fitting groove 29 firmly. This endless part 31 is intended to fit to the fitting groove 29 to support the whole of the seal member 25, and the sealing performance between the endless part 31 and the fitting groove 29 is not considered particularly.

The protruding part 32 is a part for contacting the container body 23 and the contacting surfaces 23A and 24A of the lid 24 to seal a gap between them, respectively. The protruding part 32 is provided to the endless part 31 integrally and formed with extending from the endless part 31 to outside. Provided to a tip part of the protruding part 32 is a contacting part 33 which contacts to the respective contacting surfaces 23A and 24A respectively for sealing the contacting area. This contacting part 33 is configured by two lip parts 33A and 33B. The respective lip parts 33A and 33B are formed to be a two-forked shape in their cross sections so as to contact the respective contacting surfaces 23A and 24A, respectively. Without the contacting surface 24A on the lid 24 side, the upper lip part 33A is formed so that a tip part thereof can be arranged in an upper position than the contacting surface 24A (as a status shown by the dot line in FIG. 1). Without the contacting surface 23A on the container body 23 side, the lower lip part 33B is formed so that a tip part thereof can be arranged in lower position than the contacting surface 23A (as a status shown by the dot line in FIG. 1). The respective lip parts 33A and 33B are composed of an elastic member such as a synthetic resin and are stuck to the respective contacting surfaces 23A and 24A with deforming along the respective contacting surfaces 23A and 24A as shown by the dot line in FIG. 1 when the lid 24 is mounted to the container body 23. In this status, if pressure in the container is high, gas in the container flows to outside by pushing respective lip parts 33A and 33B to open them, and, if outside atmospheric pressure is high, the gap between the container body 23 and the lid 24 is sealed because the respective lip parts 33A and 33B are pushed to be pressed to the respective contacting surfaces 23A and 24A.

The seal member 25 of the thin plate storage container 21 configured as described above is used as follows.

At first, the seal member 25 is mounted to the lid 24. Particularly, the endless part 31 of the seal member 25 is tucked into the fitting groove 29. Therefore, the contacting part 33 of the protruding part 32 is extended to sides of the respective contacting surfaces 23A and 24A. As a result, the upper lip part 33A of the contacting part 33 contacts to the contacting surface 24A with deforming along the contacting surface 24A of the lid 24 (in a status shown by the dot line in FIG. 1).

When the lid 24 is mounted to the container body 23 in this status, the lower lip part 33B of the contacting part 33 contacts to the contacting surface 23A with deforming along the contacting surface 23A of the container body 23 (in a status shown by the dot line in FIG. 1).

Since a fit body and a fitted body which are fitted to each other is the thin plate storage container for housing semiconductor wafers, the lid 24 is mounted to the container body 23, which houses semiconductor wafers, and the container body 23 is sealed. And then, the thin plate storage container is transported.

In a case where the thin plate storage container is transported by air for example, when the outside atmospheric pressure decreases while an airplane flies in the sky, the pressure in the thin plate storage container becomes higher than the outside atmospheric pressure and gas in the thin plate storage container flows to outside by pushing respective lip parts 33A and 33B to open them. In this condition, if outside atmospheric pressure becomes higher than the pressure in the container after the airplane landed on an airport, the respective lip parts 33A and 33B are pushed by the outside atmospheric pressure. As a result, the respective lip parts 33A and 33B are pressed to the respective contacting surfaces 23A and 24A to seal the gap between the container body 23 and the lid 24. Thus, a direct flow of outer air into the container body 23 is prevented. Meanwhile, a filter (not shown in the drawings) for adjusting an inner pressure of the container body 23 through the breathing depending on a change of the outer air is provided as needed.

As described above, since the protruding part 32 contacts the contacting surfaces 23A and 24A of the container body 23 and the lid 24 respectively and seals gaps between them, it is not required to modify the endless part 31 as a conventional structure and to consider the aging deterioration of a portion of the endless part 31 strongly pressed to the fitting groove 29.

Since the above mentioned protruding part 32 includes the contacting part 33 composed of two lip parts 33A and 33B formed to be two-forked shape in a cross section thereof, which contact and seal the respective contacting surfaces 23A and 24A, respectively, the respective lip parts 33A and 33B contact to the respective contacting surfaces 23A and 24A and an inflow of outside air can be prevented certainly. Especially, the respective lip parts 33A and 33B are only pressed to the respective contacting surfaces 23A and 24A by their own elastic force or, in addition, by outside atmospheric pressure, a problem of the aging deterioration is prevented and the gap between the container body 23 and the lid 24 can be sealed certainly in a good condition for long periods. As a result, intrusion of outside air into the thin plate storage container 21 can be prevented certainly. In addition, even when the respective lip parts 33A and 33B are too much softened because of heat and some effects from outside, the respective lip parts 33A and 33B are only pressed to the respective contacting surfaces 23A and 24A by outside atmospheric pressure or its own elastic force, and, thus an internal space formed by the lid 24 and the container body 23 can be sealed certainly from the outside. That is to say, the aging deterioration is prevented and the sealing performance can be maintained, improved, and stabilized.

### INDUSTRIAL APPLICABILITY

The fitting groove 29 to which the endless part 31 fits is provided to the lid 24 side in the above described embodiment. However, it goes without saying that the fitting groove 29 may be provided to the container body 23 side.

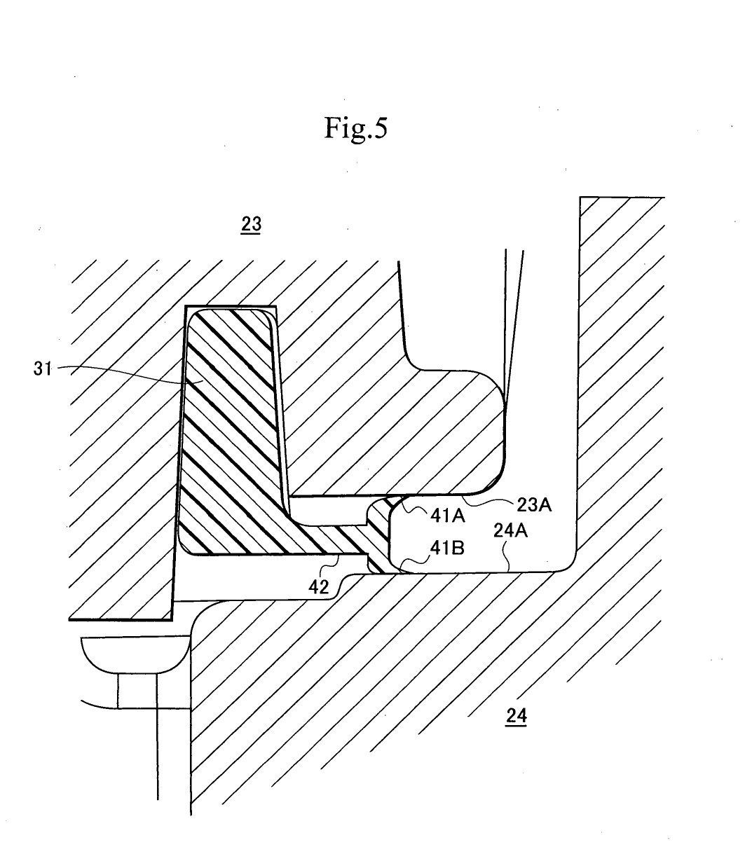

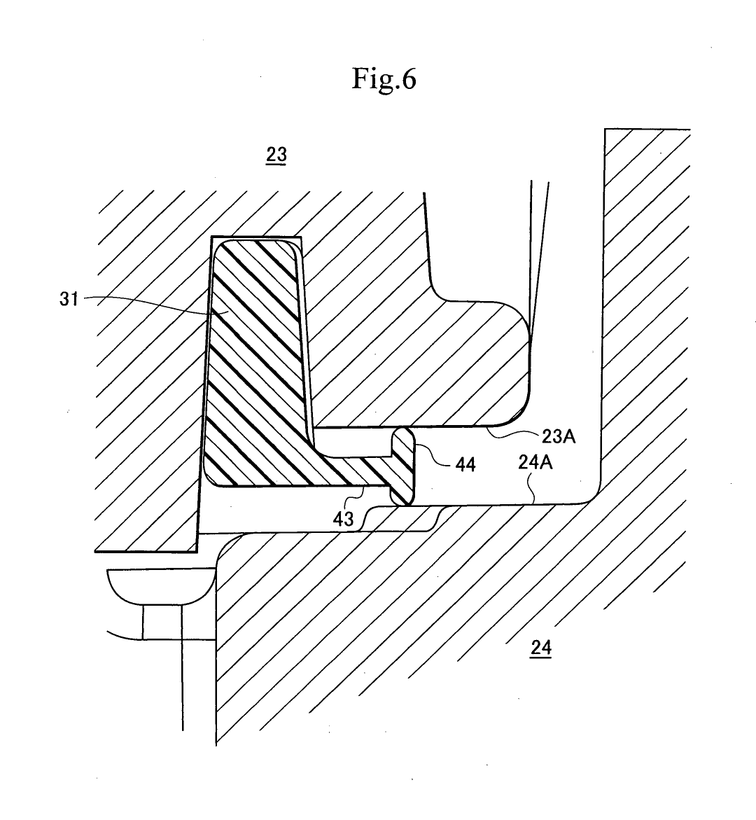

In addition, the contacting part 33 is configured by the two lip parts 33A and 33B, and however, as shown in FIG. 5 for example, and may be configured by the respective lip parts 41A and 41B contacting to the respective contacting surfaces 23A and 24A and a lip supporting part 42 arranged between the respective contacting surfaces 23A and 24A for supporting these respective lip parts 41A and 41B with contacting to the respective contacting surfaces 23A and 24A.

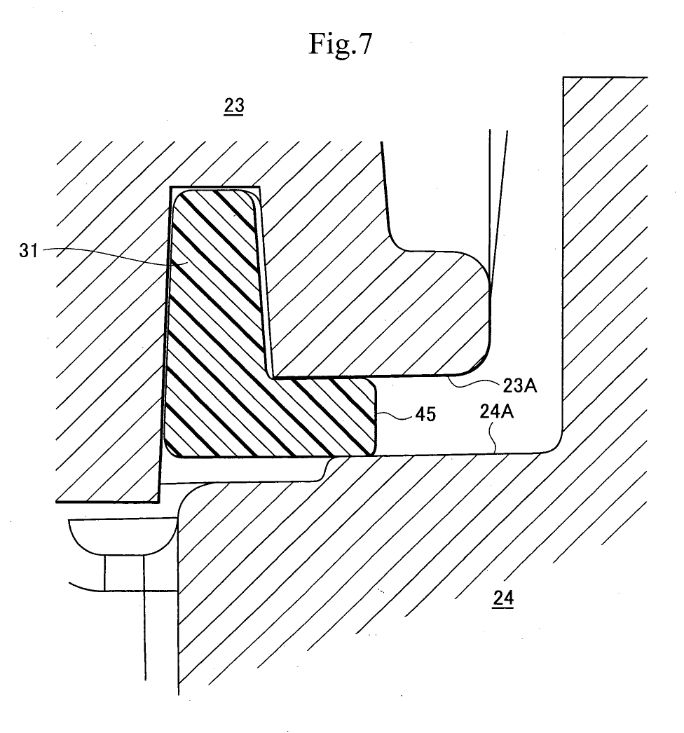

Furthermore, a case where the protruding part does not have a contacting part and a case where the contacting part is not a lip are allowable. For example, as shown in FIG. 6, a contacting part 44 which directly contacts to the respective contacting surfaces 23A and 24A from a supporting part 43 may be provided without the lip part. In addition, as the case where the protruding part does not have the contacting part, as shown in FIG. 7, a supporting part 45 may be contacted directly to the respective contacting surfaces 23A and 24A without providing the contacting part.

What is claimed is:

1. A seal member which intervenes between a fit body and a fitted body which are fitted to each other and seals a gap therebetween comprising:
an endless part for fitting to a fitting groove provided to either the fit body or the fitted body; and
a protruding part which is formed by extending from the endless part and which, through contacting of tip parts thereof, seals the contacting parts, wherein
the protruding part contacts to contacting surfaces of the fit body and the fitted body and seals a gap therebetween.

2. The seal member according to claim 1, wherein
the protruding part is configured with including a contacting part for contacting and sealing contacting surfaces of the fit body and the fitted body.

3. The seal member according to claim 2, wherein
the contacting part is composed of two lip parts formed to be two-forked shape in a cross section thereof which contact to the respective contacting surfaces, respectively.
